(19) United States
(12) Patent Application Publication
(10) Pub. No.: US 2018/0012473 A1
(43) Pub. Date: Jan. 11, 2018

(54) Childcare Activity Center

(71) Applicant: Miguel Velez, Bronx, NY (US)

(72) Inventor: Miguel Velez, Bronx, NY (US)

(21) Appl. No.: 15/643,447

(22) Filed: Jul. 6, 2017

Related U.S. Application Data
(60) Provisional application No. 62/359,071, filed on Jul. 6, 2016.

(51) Int. Cl. G08B 21/02; H04L 12/18; G06Q 10/00

(52) U.S. Cl. CPC G08B 21/0288; H04L 12/1813; G06Q 10/00

(57) ABSTRACT

A childcare activity center for entertaining and watching children during shopping activities of a parents or caregivers is provided. The child care activity center comprises a defined space at a shopping place, the defined space configured for entertaining children. A GPS device is securable to each of the children. An electronic device having a computer application communicates with the GPS device for tracking the location of a particular child. The children are capable of safely playing within the defined space while parents and caregivers shop. The parents or caregivers are able to locate a particular child at any time.

### CLAIM OF PRIORITY

This patent application claims priority under 35 USC 119 (e) (1) from U.S. Provisional Patent Application Ser. No. 62/359,071 filed Jul. 06, 2016, of common inventorship herewith entitled, “Stress Free Shopping,” which is incorporated herein by reference as though the same were set forth in its entirety.

### FIELD OF THE INVENTION

The present invention pertains to the field of childcare activity centers, and more specifically to the field of childcare activity centers in places of commerce allowing parents and caregivers to place their children to play while observing and communicating remotely with their child while shopping in various stores throughout the area.

### BACKGROUND OF THE INVENTION

Whether it's waiting on long lines, jostling against aggressive shoppers or trying to find the best price, shopping can be unpleasant. Missions to the grocery store or shopping mall require patience and determination. If one adds a child into the shopping mix, a less than relaxing experience is likely to unfold. Parents rarely are blessed with children that are amenable to the idea of being dragged from store to store. A complaining child becomes a burden for the shopper with a mission or even the leisurely shopper who simply wants to browse. Most parents find that shopping with a child in tow is often an inefficient undertaking, and the distraction of a wandering or misbehaving child is unconducive to a successful shopping endeavor. A parent or caregiver can forget something they desperately needed or pay too much for something they may have found cheaper elsewhere with a little more shopping time.

Traditionally, once a child is left in the care of a daycare center, the parent has no way to inconspicuously monitor the child's play and behavior from remote locations. Nor does the parent have a way to remotely see and speak with the child, and vice versa. This is a source of concern for both the parent and the child. The situation is further aggravated when the parent uses a new childcare center or uses a known childcare center only on an occasional basis.

The prior art has put forth several designs for daycare centers and tracking devices. Among these are:

U.S. Pat. No. 8,847,754 to James Buchheim and Arne Hennig describes a device, system and method for providing a wireless communications component, configured to send and receive wireless signals such that the device is locatable through a wireless means. The wireless communications component including a Received Signal Strength Indicator or RSSI module for measuring signal strength of a wireless signal received at the wireless communications component, wherein the device is configured to be tracked by a mobile computing device or MCD running a mobile application wherein the distance of the device from the MCD is calculated by the mobile application upon receiving between one and three RSSI values, measured by the RSSI module, and sent in a signal by the device to the MCD, wherein the distance is calculated based an average of the received RSSI values.

U.S. Pat. No. 8,654,974 to Roger B. Anderson and Jennifer B. Anderson describes a system for securing information. The system includes a first tracking device associated with an object or an individual. In one embodiment, the first tracking device generates independently a synchronous secret key and a server generates independently the synchronous secret key. Over an insecure communication channel, the server communicates an asynchronous vector pair encrypted with the synchronous secret key with the tracking device. To securely communicate information, messages are encrypted and decrypted using the asynchronous vector pair between the tracking device and the server. To further secure message information, a set of random numbers may be further utilized with the asynchronous vector pair to further encrypt and decrypt the messages communicated between the tracking device and the server.

U.S. Pat. No. 8,115,633 to Aapo Puskala, Pekka Korhonen, Niko Rusanen, Rauno Hattaka, Ari-Pekka Hiatala describes a system for tracking objects that includes providing each of at least two different objects with a transmitter having individualized identifier data. The system logically connects objects to each other by connecting the identifier data of the transmitters to each other. The system records the identifier data of the transmitters of the objects in memory storage. The system connects contact information of the object in question to the identifier data. The system detects the transmitter of the object with a receiver of an identification point when the object comes close to the identification point. Based on the identifier data contained in the memory, the system determines whether at least two objects logically connected to each other have traveled past the identification point inside a predefined time window. The system performs one or more predefined feedback actions when at least two of the objects logically connected to each other have not traveled past the identification point inside the predefined time window.

US Patent Publication 2012/0056741 to Julia Zhu Liping describes a system to track one or more indoor persons that includes an application server with a first processor, a base station, a plurality of tags, and a plurality of medical device sensors. Medical device sensors include a wireless blood pressure sensor, a wireless temperature measurement sensor or a wireless heart rate sensor with a plurality of predetermined boundary readings that are in communication with the tags, a camera that is in communication with the base station and transmits video or a plurality of picture images to the base station and a mobile device that is in communication with the base station within the system. The system can be modified to track one or more outdoor persons and one or more new or used vehicles as well.

U.S. Pat. No. 7,164,354 to Justin Panzer describes a child monitoring system for facilities and areas where parents and children generally enter and exit together, but are likely to become separated while in the facility or area. Using devices on a child's person coupled with monitoring devices on exit and entry ways, parents are alerted in the event that a child wanders off or is the subject of an abduction attempt. Upon crossing a monitoring point, an alarm is triggered to alert parents and public safety officials of an unauthorized exit attempt. A monitored child cannot leave a monitored location, such as a store or museum, alone nor without the child's parent or guardian.

US Patent Publication 2005/0120735 to Eugenia Noble describes a method and system for greatly reducing the amount of stop and go driving and shopping of a child caretaker that requires the transport of the child to and from a child activity center. Kiosk units provided at the child activity center allow for purchasing child specialty products. A kiosk center is mounted directly in a storage space or hallway at the child activity center. The system allows an attendant with lock and key and a merchant access device for credit cards to sell child specialty products conveniently and easily at the daycare center. The kiosk owner maintains the transport of goods, the shelves of which are labeled with each of the goods for sale and are seen clearly through glass windows mounted on each of the doors including a refrigerator. A drive through kiosk is provided selling child specialty products.

U.S. Pat. No. 5,786,746 to Igino Lombardo and Richard A. Slater describes a childcare system that provides a way for parents or other responsible individuals to remotely observe and communicate with their children or dependents or other charges at a care center. The system includes a video link between the care center or activity area and one or more remote areas disposed remotely from the care center. Each video link includes a video camera and monitor, permitting the parent to see his or her charge at the care center, and vice versa. The system includes a telephone link between the sites, permitting voice communication between the parent and the charge. The system provides a paging link whereby an adult supervisor at the center can page the parent and alert him or her to contact the center via phone. A lockout is provided to insure that only authorized parents can view charges at the care center.

None of these prior art references describe the present invention.

### SUMMARY OF THE INVENTION

It is an object of the present invention to provide childcare activity centers in places of commerce where parents and caregivers can drop their children to play, and they can observe and communicate remotely with their child while shopping in various stores throughout the area.

The present invention is a childcare activity center for entertaining and watching children during shopping activities of a parents or caregivers. The child care activity center comprises a defined space at a shopping place with the defined space configured for entertaining children. A GPS device is securable to each of the children. An electronic device having a computer application communicates with the GPS device for tracking the location of a particular child. The children are capable of safely playing within the defined space while parents and caregivers shop. The parents or caregivers are able to locate a particular child at any time.

In addition, the present invention includes a method for watching and entertaining children during shopping activities. The method comprises providing a defined space at a shopping place, configuring the defined space for entertaining children, securing a GPS device to each of the children, providing an electronic device having a computer application, communicating the electronic device with the GPS device, and tracking the location of a particular child.

The present invention further includes a childcare activity center for placing children during shopping activities. The child care activity center comprises a defined space at a shopping place with the defined space configured for entertaining children. A GPS device is securable to each of the children with the GPS device being a GPS sticker. At least one camera is positioned in or near the physical space with the camera directed at the physical space for viewing all activities arising in the physical space. A microphone and speaker are associated with the at least one camera. An electronic device having a computer application communicates with the GPS device, the at least one camera, and the microphone and speaker. The children are capable of safely playing within the defined space while parents and caregivers shop. The parents or caregivers are able to locate a particular child at any time. The parent and caregiver through the computer application is capable of remotely observing through the camera and communicating through the microphone and speaker with the children.

### BRIEF DESCRIPTION OF THE DRAWINGS

FIG. 1 is a perspective view illustrating a childcare activity center, constructed in accordance with the present invention, showing rubber flooring, framed pictures, shelves, stools, climbing bars, and a playhouse with a slide.

FIG. 2 is a perspective view illustrating the childcare activity center, constructed in accordance with the present invention, showing rubber flooring, windows, cushioned benches, and a playhouse with a slide.

FIG. 3 is a perspective view illustrating the childcare activity center, constructed in accordance with the present invention, showing rubber flooring, shelves, wall mounted hanging hooks, tables and chairs, a wall mounted television, and a dive in play box with balls.

FIG. 4 is a perspective view illustrating the childcare activity center, constructed in accordance with the present invention, showing rubber flooring, windows, cushioned benches, a corner countertop, and the step and climb bar side of a playhouse with a slide.

FIG. 5 is a front elevational view illustrating a GPS sticker of the childcare activity center, constructed in accordance with the present invention.

FIG. 6 is a front elevational view illustrating a cellular phone for use with the childcare activity center, constructed in accordance with the present invention.

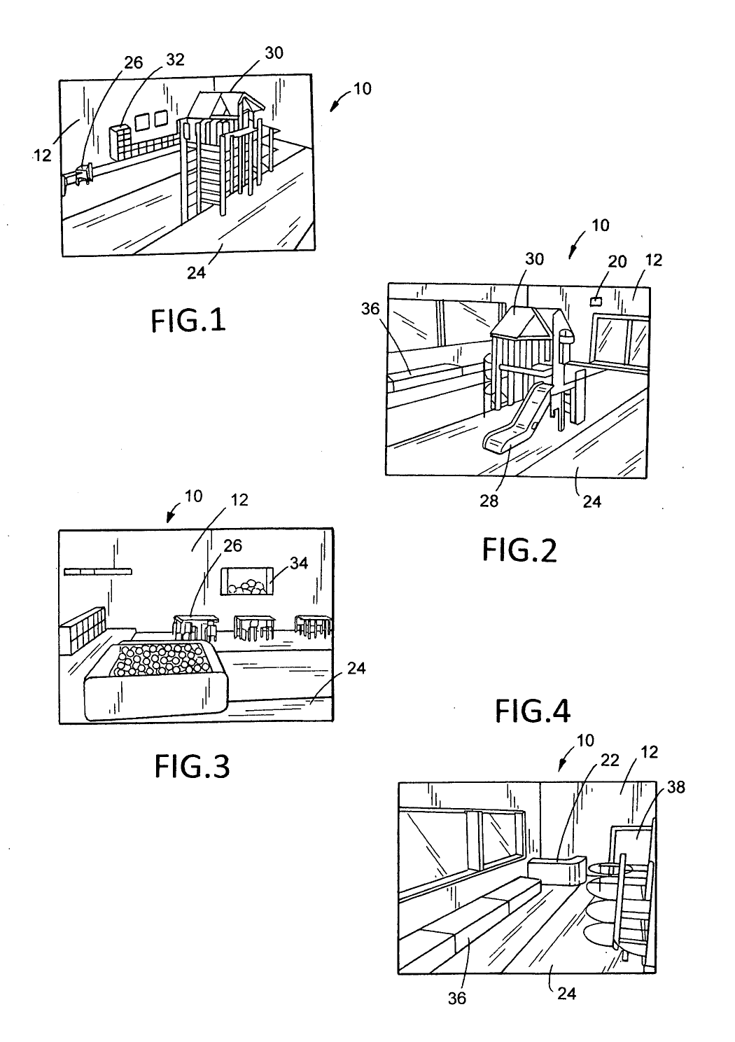

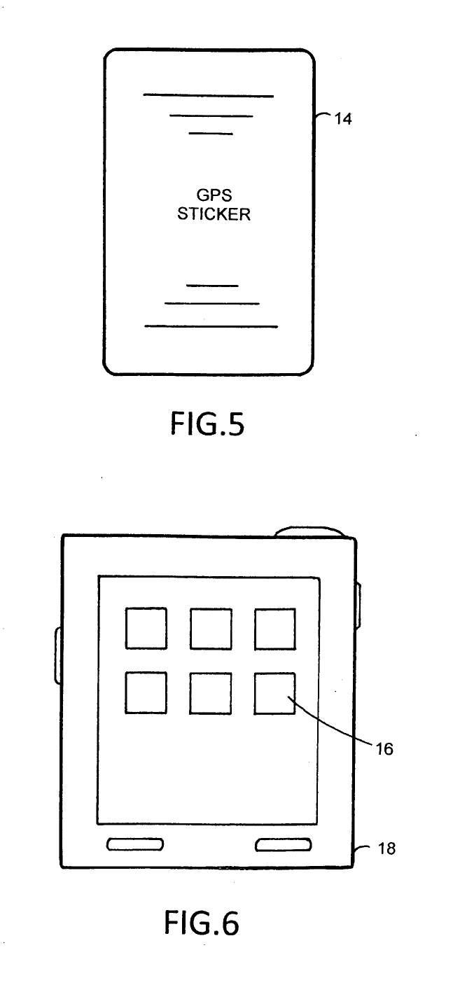

### DETAILED DESCRIPTION OF THE INVENTION

The present invention, hereinafter referred to as a Childcare Activity Center, indicated generally at 10, pertains to a childcare or daycare activity center located in a place of commerce such as a supermarket, shopping mall, or department store. The Childcare Activity Center 10 of the present invention provides a physical place 12 for children to safely play while parents and caregivers tackle a shopping list or leisurely enjoy a shopping spree. In addition, the Childcare Activity Center 10 provides a capability for a parent or caregiver to remotely observe and communicate with their child while they shop. In this way, parents no longer are stressed trying to keep up with their children in a shopping mall or center. The parents or caregivers know the children are safely and happily playing in an activity center place 12 configured for children and are able to verify the child's experience is going smoothly in the care center place 12.

Upon leaving a child at the Childcare Activity Center 10 of the present invention, the parent receives a Global Positioning System or GPS sticker application 14 that adheres to the child's back or other part of their body. The GPS sticker 14 is associated with a particular child and trackable by a cell phone application or program 16 on a cell phone 18 or other electronic device, allowing the parent to remotely track the child and know their whereabouts at all times while the parent is shopping. In addition, the Childcare Activity Center 10 includes a camera 20 or video link, between the childcare activity center place 12 and wherever the parent is located, that is accessible and viewable by means of a cell phone application or program 16 on a cell phone 18 or other electronic device. Furthermore, the Childcare Activity Center 10 includes a paging link whereby an adult supervisor at the childcare activity center place 12 can page and alert the parent to contact the center by phone 18.

The Childcare Activity Center 10 of the present invention typically requires leasing, purchasing, or adding space in a shopping center or another similar place of commerce where parents and caregivers can drop their children to play while they shop. The physical space and layout of the Childcare Activity Center 10 varies depending on the retail space it inhabits. Each Childcare Activity Center 10 has a reception desk 22 for caregivers to register and sign in their child or children. The flooring 24 is preferably constructed with interlocking rubber floor tiles commonly found in playground flooring. These thick safety tiles of the flooring 24 are manufactured with a commercial grade, shock absorbing and resilient rubber allowing children to play without high risk of permanent injury.

Each Childcare Activity Center 10 of the present invention houses children's furniture such as tables 26 for children to draw, sculpt or play games. Slides 28, playhouses 30, rockers, and play kitchen sets are provided for the children. Located on one side of the facility are shelves 32 for storing games, toys, puzzles, and books. On that same wall is a large flat screen TV 34 for children's programming to run continuously. On the opposite side of the room is a long bench 36 utilized for seating. Closets 38 with coat hooks, cubbies, and lockers can store the child's belongings, such as a coat, tablet or toy. The facilities of the Childcare Activity Center 10 are vibrant and colorful.

Upon arrival at the Childcare Activity Center 10 of the present invention, the parent or caregiver registers at the desk, providing all pertinent contact information and whether the child has any existing health care issues such as allergies. The parent or caregiver then downloads a software application on their phone that allows remote monitoring and constant communication. The parent then leaves to go shopping while the child or children remain in the childcare activity center, enjoying fun activities and a snack with beverage if they are there for more than an hour.

The Childcare Activity Center 10 of the present invention enables parents and caregivers an unencumbered shopping experience while providing children with pleasant play activities. At the same time, shoppers without children are spared shrill sounds of children squealing as they run throughout store aisles and dressing rooms. Allowing constant remote communication between parent and child, The Childcare Activity Center 10 turns shopping into a leisurely activity for a parent and a safe playtime for a child. Accessing the Childcare Activity Center 10, both caregiver and child can enjoy an excursion to a place of commerce.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A childcare activity center for entertaining and watching children during shopping activities of a parents or caregivers, the child care activity center comprising:
a defined space at a shopping place, the defined space configured for entertaining children;
a GPS device securable to each of the children;
an electronic device having a computer application communicating with the GPS device for tracking the location of a particular child;
wherein the children are capable of safely playing within the defined space while parents and caregivers shop; and
wherein the parents or caregivers are able to locate a particular child at any time.

2. The childcare activity center of claim 1 and further comprising:
at least one camera positioned in or near the physical space, the camera directed at the physical space, for viewing all activities arising in the physical space;
a microphone and speaker associated with the at least one camera;
wherein the parent and caregiver through the computer application is capable of remotely observing through the camera and communicating through the microphone and speaker with the children.

3. The childcare activity center of claim 1 wherein the shopping place is selected from the group consisting of a supermarket, a shopping mall, and a department store.

4. The childcare activity center of claim 1 wherein the GPS device is a GPS sticker adherable to each of the children.

5. The childcare activity center of claim 1 wherein the electronic device is a cell phone allowing the parent or caregiver to remotely track a particular child and know their whereabouts at all times while the parent is shopping.

6. The childcare activity center of claim 1 and further comprising:
a paging link for paging and alerting a parent or caregiver to contact the childcare activity center.

7. The childcare activity center of claim 1 wherein the defined space is leased, purchased, or added to the shopping place.

8. The childcare activity center of claim 1 wherein the defined space has a varying physical space and layout depending on the shopping place.

9. The childcare activity center of claim 1 wherein the defined space has flooring constructed with interlocking rubber floor tiles.

10. The childcare activity center of claim 1 wherein the defined space has children's furniture, slides, playhouses, rockers, shelves, and play kitchen sets.

11. The childcare activity center of claim 1 and further comprising:
a television mounted within the defined space for children's programming to run continuously.

12. The childcare activity center of claim 1 and further comprising:
at least one closet with coat hooks, cubbies, and lockers positioned within the defined space.

13. A method for watching and entertaining children during shopping activities, the method comprising:
providing a defined space at a shopping place;
configuring the defined space for entertaining children;
securing a GPS device to each of the children;
providing an electronic device having a computer application;
communicating the electronic device with the GPS device; and
tracking the location of a particular child.

14. A childcare activity center for placing children during shopping activities, the child care activity center comprising:
a defined space at a shopping place, the defined space configured for entertaining children;
a GPS device securable to each of the children, the GPS device being a GPS sticker;
at least one camera positioned in or near the physical space, the camera directed at the physical space, for viewing all activities arising in the physical space;
a microphone and speaker associated with the at least one camera;
an electronic device having a computer application communicating with the GPS device, the at least one camera, and the microphone and speaker;
wherein the children are capable of safely playing within the defined space while parents and caregivers shop;
wherein the parents or caregivers are able to locate a particular child at any time; and
wherein the parent and caregiver through the computer application is capable of remotely observing through the camera and communicating through the microphone and speaker with the children.

15. The childcare activity center of claim 14 wherein the electronic device is a cell phone allowing the parent or caregiver to remotely track a particular child and know their whereabouts at all times while the parent is shopping.

16. The childcare activity center of claim 14 and further comprising:
a paging link for paging and alerting a parent or caregiver to contact the childcare activity center.

17. The childcare activity center of claim 14 wherein the defined space is leased, purchased, or added to the shopping place.

18. The childcare activity center of claim 14 wherein the defined space has a varying physical space and layout depending on the shopping place.

19. The childcare activity center of claim 14 wherein the defined space has flooring constructed with interlocking rubber floor tiles.

20. The childcare activity center of claim 14 wherein the defined pace has children's furniture, slides, playhouses, rockers, shelves, and play kitchen sets, a television mounted within the defined space for children's programming to run continuously, and at least one closet with coat hooks, cubbies, and lockers positioned within the defined space.
